(19) United States
(12) Patent Application Publication
(10) Pub. No.: US 2018/0253769 A1
(43) Pub. Date: Sep. 6, 2018

(54) METHOD AND APPARATUS FOR SELECTING AND RECOMMENDING PRESENTATION OBJECTS ON ELECTRONIC DISTRIBUTION PLATFORMS

(71) Applicants: Suli Ye, Hangzhou, Zhejiang (CN); Zheng Dai, Hangzhou, Zhejiang (CN); Aijuan Zhao, Hangzhou, Zhejiang (CN); Fan Chen, Hangzhou, Zhejiang (CN); Jiliang Ou, Hangzhou, Zhejiang (CN); ALIBABA GROUP HOLDING LIMITED, Grand Cayman (KY)

(72) Inventors: Suli YE, Hangzhou (CN); Zheng DAI, Hangzhou (CN); Aijuan ZHAO, Hangzhou (CN); Fan CHEN, Hangzhou (CN); Jiliang OU, Hangzhou (CN); Pun Kok CHIA, Hangzhou (CN)

(21) Appl. No.: 15/753,201

(22) PCT Filed: Aug. 11, 2016
(86) PCT No.: PCT/CN2016/094661

§ 371 Date: Feb. 16, 2018

(30) Foreign Application Priority Data
Aug. 20, 2015 (CN) 201510515860.3

(51) Int. Cl. G06Q 30/06; H04L 29/08

(52) U.S. Cl. CPC G06Q 30/0609; H04L 67/1002; G06Q 30/0625; G06Q 30/0641

(57) ABSTRACT

The disclosed embodiments provide methods and apparatuses for selecting and recommending presentation objects, so as to solve the problems in current systems where presentation objects for participating in a service are determined manually which have the problems of subjectivity, low efficiency, and have high error rates. The selection method comprises: receiving, by a sub-server, service participation request messages sent by each first user terminal, wherein the service participation request messages include identifiers of presentation objects; determining, according to corresponding relationships between the identifiers of the presentation objects and identifiers of first users obtained from a main server, identifiers of first users corresponding to the identifiers of the presentation objects included in the received service participation request messages; obtaining, from the main server, historical behavior information of the first users indicated by the determined identifiers of the first users; determining, according to the obtained historical behavior information of the first users, first users satisfying a set service participation condition; and selecting a presentation object from presentation objects for which the request to participate in a service is placed by the first users satisfying the set service participation condition.

### CROSS-REFERENCE TO RELATED APPLICATIONS

The present disclosure claims priority to Chinese Patent Application No. 201510515860.3, filed on Aug. 20, 2015 entitled “APPARATUS FOR SELECTION AND RECOMMENDATION OF OBJECTS FOR DISPLAY” and PCT Appl. No. PCT/CN16/94661 filed on Aug. 11, 2016 and entitled “METHOD AND DEVICE FOR SELECTING AND RECOMMENDING DISPLAY OBJECT,” both incorporated herein by reference in their entirety.

### BACKGROUND

### Technical Field

The disclosure relates to the field of data processing technologies, and in particular, to a method and an apparatus for selecting and recommending a presentation objects on electronic distribution platforms.

### Description of the Related Art

To attract consumers as well as to promote presentation objects (e.g., digital representations of goods or services) in various ways to improve the sales volume of the presentation objects, e-commerce platforms, especially C2C (Consumer to Consumer) e-commerce platforms usually associate different sub-servers (for running sub-business platforms) under a main server (for running a business platform), with each sub-server hosting a different service.

For example, a sub-server A1 and a sub-server A2 are associated under a main server A. The main server A is used for providing a conventional selling service of presentation objects, the sub-server A1 is used for providing a group purchase promotion service of the presentation objects, and the sub-server A2 is used for providing a rebate promotion service of the presentation objects.

In this case, the presentation objects on the main server A are eligible to be included in the group purchase promotion service of the sub-server A1 and what needs to be determined is whether a presentation object can actually be included in the group purchase promotion service. If a presentation object O1 is selected to be included in the group purchase promotion service, a first user (for example, a selling user providing the presentation object O1) of the presentation object O1 may create a group purchase promotion offer for the presentation object O1 on the sub-server A1. Similarly, the presentation objects on the main server A are eligible to be included in the rebate promotion service of the sub-server A2 and what needs to be determined is whether a presentation object can actually be included in the rebate promotion service. If a presentation object O2 is selected to participate in the rebate promotion service, a first user of the presentation object O2 may create a rebate promotion offer for the presentation object O2 on the sub-server A2.

To avoid presenting problematic (for example, forged and fake) presentation objects on the sub-servers that might negatively influence the user experience of users (e.g., users viewing or purchasing the presentation objects) or even cause harm to users, administrators of the sub-servers usually need to choose presentation objects that can be included in a service according to the various information associated with presentation objects participating in the service, such as prices and historical transaction information. This selecting avoids presenting any questionable presentation objects to consumers.

Currently, selecting presentation objects to be included in a service as described previously is mostly performed manually based on experience. This determination method has the problems of subjectivity, heavy workload, low efficiency, and increased labor costs. Additionally, the manual-based selection and determination of presentation objects for participating in a service tends to have higher error rates with greater integrity risks.

### SUMMARY

Embodiments of the disclosure provide a method and an apparatus for selecting and recommending presentation objects, so as to solve the problems in current systems where presentation objects for participating in a service are determined manually which have the problems of subjectivity, low efficiency, and have high error rates.

Disclosed is a method for selecting a presentation object, comprising: receiving, by a sub-server, service participation request messages sent by each first user terminal, wherein the service participation request messages include identifiers of presentation objects; determining, according to corresponding relationships between the identifiers of the presentation objects and identifiers of first users obtained from a main server, identifiers of first users corresponding to the identifiers of the presentation objects included in the received service participation request messages; obtaining, from the main server, historical behavior information of the first users indicated by the determined identifiers of the first users; determining, according to the obtained historical behavior information of the first users, first users satisfying a set service participation condition; and selecting a presentation object from presentation objects for which the request to participate in a service is placed by the first users satisfying the set service participation condition.

Disclosed is a method for recommending presentation objects selected by using the above method, wherein each presentation object corresponds to one or more consumption levels and one or more interest tags, and the recommendation method comprises: determining a purchasing power level and an interest tag being of interests to a second user according to historical behavior information of the second user; further selecting, from the selected presentation objects, presentation objects with corresponding interest tags being of interest to the second user and corresponding consumption levels thereof matching the purchasing power level of the second user; and recommending to the second user web pages containing the further selected presentation objects when the second user accesses the sub-server.

Disclosed is an apparatus for selecting a presentation object, comprising: a receiving module, configured to receive service participation request messages sent by each first user terminal, wherein the service participation request messages include identifiers of presentation objects; a first determining module, configured to determine, according to corresponding relationships between the identifiers of the presentation objects and identifiers of first users obtained from a main server, identifiers of first users corresponding to the identifiers of the presentation objects included in the received service participation request messages; a second determining module, configured to obtain, from the main server, historical behavior information of the first users indicated by the determined identifiers of the first users; a third determining module, configured to determine, according to the obtained historical behavior information of the first users, first users satisfying a set service participation condition; and a first selection module, configured to select a presentation object from presentation objects for which the request to participate in a service is placed by the first users satisfying the set service participation condition.

Disclosed is an apparatus for recommending presentation objects selected by using the above apparatus, wherein each presentation object corresponds to one or more consumption levels and one or more interest tags, and the recommendation apparatus comprises: a fifth determining module, configured to determine a purchasing power level and an interest tag being of interests to a second user according to historical behavior information of the second user; a second selection module, configured to further select, from the selected presentation objects, presentation objects with corresponding interest tags being of interest to the second user and corresponding consumption levels thereof matching the purchasing power level of the second user; and a recommendation module, configured to recommend to the second user web pages containing the further selected presentation objects when the second user accesses the sub-server.

In the solutions provided in the embodiments of the present application, a presentation participation condition is preset for first users. It is determined whether a first user is a first user satisfying the set service participation condition according to historical behavior information of the first user. If the first user satisfies the set service participation condition, some or all of the presentation objects are selected from the presentation objects for which the request to participate in a service is placed by the first users. This makes it possible for a main server to automatically, relatively objectively, and accurately select presentation objects from the main server that can be included in the presentation service of a sub-server when a need to determine, in the main server, presentation objects that can be included in the presentation service of the sub-server arises. Moreover, because presentation objects participating in the service are first filtered at the source, first users, by using information of first users, this present application avoids presenting problematic presentation objects to consumers effectively, reducing the subsequent number of presentation objects to be determined, thereby improving the shopping experience of second users and increasing the efficiency in selecting presentation objects.

### BRIEF DESCRIPTION OF THE DRAWINGS

FIG. 1 is a flow diagram of a method for selecting a presentation object according some embodiments of the disclosure.

FIG. 2 is a flow diagram of a method for recommending a presentation object according some embodiments of the disclosure.

FIG. 3 is a block diagram of an apparatus for selecting a presentation object according to some embodiments of the disclosure.

FIG. 4 is a block diagram of an apparatus for recommending a presentation object according to some embodiments of the disclosure.

### DETAILED DESCRIPTION

To avoid the problems of subjectivity, low efficiency, and high error rates when a sub-server determines presentation objects in a main server that can be included in a service of a sub-server, embodiments of the disclosure provide methods for selecting a presentation object. In the method, first, a sub-server receives a service participation request message sent by a first user terminal that carries identifiers of presentation objects and determines, by using the corresponding relationships between identifiers of presentation objects and identifiers of first users stored in a main server, a first user corresponding to the presentation objects for which the service participation request is placed. Then, the method obtains historical behavior information of the first user from the main server and determines, according to the obtained historical behavior information, whether the determined first user satisfies a set service participation condition. Finally, the method selects some or all of the presentation objects from the presentation objects for which the service participation request is placed by the first user as determined presentation objects when it is determined that the first user satisfies the set service participation condition. This makes it possible for the main server to automatically, relatively objectively, and accurately select presentation objects from the main server that can be included in the presentation service of a sub-server when a need arises to determine, in the main server, presentation objects that can be included in the presentation service of the sub-server. Moreover, because presentation objects participating in the service are first filtered at the source by using information of first users, the disclosed embodiments avoid presenting problematic presentation objects to consumers, effectively reducing the subsequent number of presentation objects to be determined and thereby improving the shopping experience of second users and increasing the efficiency in selecting presentation objects.

To describe the solutions provided in the embodiments of the present application, information stored or recorded on the main server is first described below.

Features and historical transaction behavior features of each presentation object are included. The features of the presentation object may include one or more of a price, an inventory, a category, and a gender preference, one or more corresponding leaf categories, and one or more corresponding consumption levels. The historical transaction behavior features of the presentation object include one or more of a sales volume, a refund rate, a poor evaluation rate, an adding to favorite volume, a search volume, a browse volume, and historical text evaluation information. Operation features of a store include one or more of a star level, a delivery speed, quality of service, and a store operation time.

Corresponding relationships between an identifier of each first user and identifiers of presentation objects presented on the main server by the first user.

Behavior information produced in the process of selling the presentation objects presented on the main server by each first user and behavior information produced in the preparation for selling the presentation objects; these behavior information, contrasting to the current behavior information is pre-generated is referred to as historical behavior information. The historical behavior information of the first user records historical behaviors of the first user.

For example, the historical behavior information may include a store registration record (a registration time, a registered main category, a registered current residence, a registered mobile phone number, a registered e-mail address, etc.), a store login record (a login duration at a store, an identifier of a device used for logging into the store, and an Internet Protocol (IP) address used to log into the store, etc.), and the information may also include one or more of a historical penalty score, a record of selling counterfeits, a record of defrauding second users, a record of selling objects prohibited to be presented, a record of false certifications, and a bribery record. The above information that may also be included may be obtained through a record of second user complaints and a record of network administrator examinations.

The record of selling counterfeits, the record of defrauding users, the record of selling objects prohibited to be presented, the record of using false certifications, and the bribery record herein may be called “unethical records.” The historical penalty score reflects the overall severity of these unethical records and the number of occurrences. Each time an unethical record is observed, the historical penalty score may be increased by a score corresponding to that unethical record. Generally, a greater number of records of selling counterfeits, defrauding, selling objects prohibited to be presented, using false certifications, and bribery gives rise to a higher historical penally score.

Behavior information produced when each second user accesses the main server is, historical behavior information of the second user; examples of this kind of information are behaviors (such as purchasing/browsing/adding to favorite/adding to a shopping cart), an identifier of a presentation object targeted by the behavior, and information about the occurrence time of the behavior; and text evaluation information for the presentation object; evaluation information for a delivery speed of a store to which the presentation object belongs, quality of service, and a degree of conformity to description store to which the and the like.

Some of the disclosed embodiments are described below with reference to the accompanying drawings. It should be understood that the embodiments described herein are only for illustrating and explaining the disclosure, and not for limiting the embodiments. Moreover, without conflicts, the disclosed embodiments and the features in the embodiments may be combined with one another.

The methods and apparatuses provided by the disclosure are described in detail below using specific embodiments with reference to the accompanying drawings.

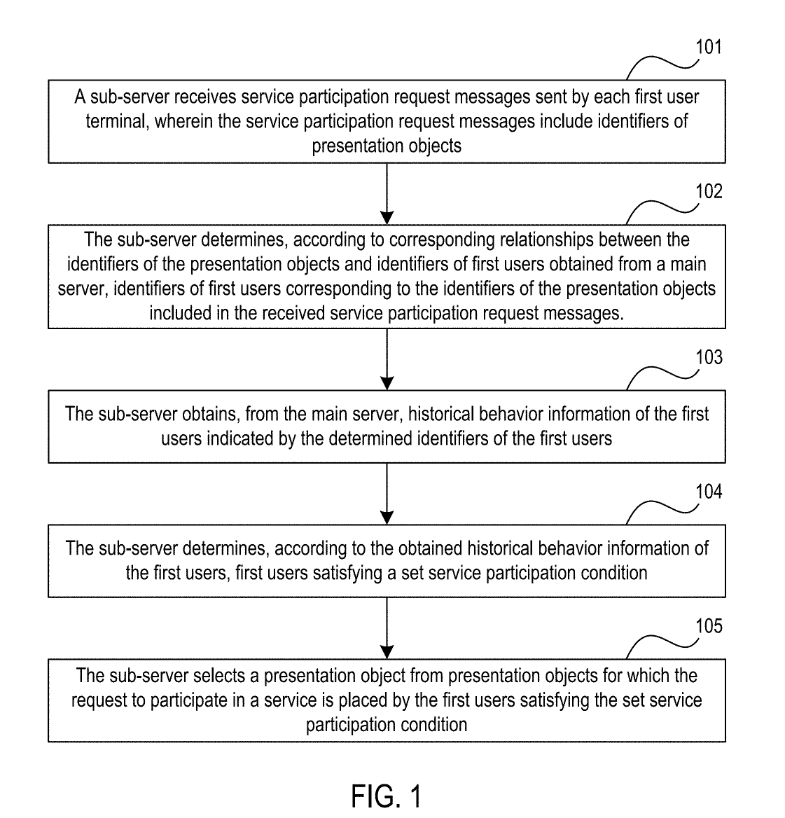

FIG. 1 is a flow diagram of a method for selecting a presentation object according some embodiments of the disclosure. The method includes the following steps.

Step 101:

A sub-server receives service participation request messages sent by each first user terminal, wherein the service participation request messages include identifiers of presentation objects.

When first users indicated by identifiers of the first users included in a main server need to request that presentation objects of the first users in the main server to be included in a service of the sub-server, the first users may use first user terminals to include identifiers of the presentation objects for which the request to participate in a service is placed. The first user terminals may then send the service participation requests to the sub-server.

Herein, the presentation objects indicated by the identifiers of the presentation objects included in the service participation request messages are the presentation objects for which the request to participate in a service is placed. The sub-server may identify the presentation objects for which the request to participate in a service is placed through this step 101 and, subsequently, determine whether these presentation objects for which the request to participate in a service is placed can be included in presentation.

Step 102:

The sub-server determines, according to corresponding relationships between the identifiers of the presentation objects and identifiers of first users obtained from a main server, identifiers of first users corresponding to the identifiers of the presentation objects included in the received service participation request messages.

The main server stores a corresponding relationship between an identifier of each first user and an identifier of a presentation object presented on the main server by the first user. Each time the first user adds a presentation object, the main server may establish a corresponding relationship between the newly added presentation object and the identifier of the first user. Each time the first user deletes a presentation object, a corresponding relationship between the deleted presentation object and the identifier of the first user may be deleted accordingly.

After receiving the service participation request messages sent by the first user terminals, the sub-server may send a corresponding relationship request message to the main server to obtain the corresponding relationships from the main server. Because the corresponding relationships obtained in this manner are the most up-to-date, the identifiers of the first users corresponding to the identifiers of the presentation objects included in the received service participation request messages can be more accurately determined by using the corresponding relationships obtained in this manner.

The sub-server may also send the corresponding relationship request message to the main server to obtain the corresponding relationships from the main server before receiving the service participation request messages sent by the first user terminals.

Step 103:

The sub-server obtains, from the main server, historical behavior information of the first users indicated by the determined identifiers of the first users. The historical behavior information of the first users has already been described above and details are not described herein again.

In step 103, the method obtains the historical behavior information of the first users to provide a basis for a subsequently determining of whether a first user, corresponding to a presentation object for which the request to participate in a service is placed, satisfies a set service participation condition.

Step 104:

The sub-server determines, according to the obtained historical behavior information of the first users, first users satisfying a set service participation condition.

The set service participation condition herein is a condition for filtering the first users. The main purpose is to filter first users that sell problematic presentation objects.

Considering that a first user that has sold a certain problematic presentation object is quite likely to still sell other problematic presentation objects now or in the future, problematic first users are filtered out in step 104, thereby achieving the effect of preventing problematic presentation objects from being provided to consumers at the source, first users.

A problematic presentation object comes from a first user. After this problematic presentation object is displayed and sold, a second user and other users would provide feedback on the presentation object and the store. For example, a negative rating may be given, a complaint might be filed for the first user selling a counterfeit and defrauding, a report might be filed for the first user selling an object prohibited to be presented, for the first user using a false certification, and for the first user involving in bribery. These feedbacks and reports finally reflect historical behaviors of the first user and are recorded in historical behavior information of the first user.

Based on the above analysis, problematic presentation objects are prevented from being presented to second users accessing the sub-server; and the set service participation condition may be determined according to historical behavior information of first users providing problematic presentation objects. Certainly, the set service participation condition may also be determined in combination with other factors, which is not limited herein.

Two implementations of the service participation condition are described below.

In a first implementation, the method uses a historical penalty score being less than a first set value as the set service participation condition.

That is, regarding a first user indicated by each determined identifier of the first user, it is determined whether a historical penalty score of the first user is less than the first set value. If so, it is determined that the first user is a first user satisfying the set service participation condition. If not, it is determined that the first user is a first user not satisfying the set service participation condition.

The historical penalty score reflects the number and severity of unethical records of a first user. Therefore, a higher score indicates a higher number and severity of unethical records of the first user. The method will filter out first users having a historical penalty score greater than the first set value.

In a second implementation, a historical penally score being less than a first set value and a first user being not the same first user as a determined unethical first user is used as the set service participation condition.

The steps of the second implementation may include the following steps.

Step 1:

Determine unethical first users according to historical behavior information of first users from first users indicated by identifiers of the first users stored in the main server but not the first users indicated by the determined identifiers of the first users.

The unethical first users include: a first user selling a counterfeit, a first user defrauding a second user, a first user selling an object prohibited to be presented, a first user using a false certification, and a first user having a bribery problem.

The main server records historical behavior information of all first users. Therefore, the unethical first users may be determined according to the historical behavior information of the first users of the first users indicated by the identifiers of the first users stored in the main server, but not the first users indicated by the determined identifiers of the first users.

Step 2:

Identifying a first user indicated by each determined identifier of the first user, determine whether a historical penalty score of the first user is less than the first set value; and if so, perform step 3; and if not, perform step 5.

A determining process in step 2 herein is the same as that in the first implementation above and details are not described again.

Step 3:

Determine, according to store registration records and store login records of the first user, whether any unethical first user exists in the determined unethical first users that is the same first user as the first user; and if so, perform step 4; and if not, perform step 5.

The preceding disclosure describes the store registration record and the store login record and the corresponding details are therefore not described again.

In a network, one first user may register with multiple accounts (that is, identifiers of the first user) and operate at multiple stores at the same time. Although the identifiers of the first user are different, the identifiers may actually correspond to the same first user. The first user may present and sell a presentation object having no issues in one store A1 of the first user with a historical penally score being less than the set value. But the same first user may present and sell a problematic presentation object in store A2. In this case, a first user indicated by an identifier used by the first user for the store A1 can satisfy the set service participation condition. Once the set service participation condition is satisfied, the first user may participate in a service of the sub-server with a problematic presentation object. Therefore, in step 3 herein, it is needed to determine whether an unethical first user exists in the determined unethical first users that is the same as the first user. That is, to determine whether the first user is the same unethical first user in the unethical first users, so as to avoid providing problematic presentation objects to second users at all costs.

For the same first user operating at multiple stores, registration information filled in when the different stores are registered, i.e., store registration records, is highly likely to be similar to a great extent. Devices used when the stores are logged in, time periods of logging into the stores, IP addresses used to log into the stores are also highly likely to be similar to a great extent. Therefore, it can be determined whether an unethical first user exists among the determined unethical first users that is the same as the first user by comparing the store registration record and the store login record of the first user with store registration records and store login records of the unethical first users in the unethical first users.

When the store login record includes a login duration at a store, an identifier of a device used for logging into the store, and a network Internet Protocol (IP) address used to log into the store, an implementation of step 3 may be as follows: determine whether any one or more of the following three types of unethical first users in the determined unethical first users, and if so, determine that an unethical first user exists that is the same first user as the first user; and if not, determine that no unethical first user exists that is the same first user as the first user. A first type of unethical first user may comprise an unethical first user that logs into a store by using a device having the same identifier as the identifier of the device used by the first user to login to the store, and logs into the store by using the device for a duration greater than a second set value. A second type of unethical first user may comprise an unethical first user who logs into a store by using the same IP address as the IP address used by the first user to login to the store, and logs into the store by using the IP address for a duration greater than the second set value. A third type of unethical first user may comprise an unethical first user who has a store registration record having a similarity to the store registration record of the first user greater than a third set value.

Step 4:

Determine that the first user is a first user satisfying the set service participation condition.

Step 5:

Determine that the first user is a first user not satisfying the set service participation condition.

Step 105:

The sub-server selects a presentation object from presentation objects for which the request to participate in a service is placed by the first users satisfying the set service participation condition.

In step 105, the sub-server may use multiple methods to select a presentation object from some of the presentation objects for which the request to participate in a service is placed by the first users satisfying the set service participation condition. For example, a first method is random selection. A second method is selection according to prices of the presentation objects. A third method is selection according to whether a category to which a presentation object for which the request to participate in a service is placed matches a current category for which the service hosted by the sub-server is provided, wherein when the categories match, the presentation object for which the request to participate in a service is placed is selected and when the categories do not match, the presentation object for which the request to participate in a service is placed is not selected.

The presentation object selected in step 105 may be all of the presentation objects or may be some of the presentation objects.

An implementation of this step 105 is given below. The presentation object may be selected from presentation objects for which the request to participate in a service is placed by the first users satisfying the set service participation condition in the following manner.

For each presentation object for which the request to participate in a service is placed by the first users satisfying the set service participation condition, the following steps a1 to f1 are performed.

Step a1:

Determine a poor-quality index value of the presentation object.

Some presentation objects are not fake presentation objects, but there might be some problems with their quality. To avoid providing such presentation objects to second users, information reflecting that the presentation objects are presentation objects with poor quality needs to be quantified, so as to determine poor-quality index values of the presentation objects.

The level of a determined poor-quality index value reflects the severity of the poor-quality of a presentation object. A higher poor-quality index value indicates a higher severity of the poor-quality of the presentation object.

Specifically, the poor-quality index value of the presentation object may be determined by determining the poor-quality index value of the presentation object according to one or more of the following information of a store to which the presentation object belongs: a detailed first user rating DSR (detailed first user rating) score, price information, historical text evaluation information, and refund rate information.

The DSR includes three dimensions: a conformity of commodity to description, a service quality of a first user, and a package delivery speed. The DSR score directly indicates the quality and detail of the presentation object. Therefore, the DSR can be used to determine the poor-quality index value of the presentation object.

When the price of the presentation object deviates far from an average price of presentation objects having the same style and the same material, it indicates that the presentation object may be a presentation object with poor quality. A degree of deviation may be used to determine the poor-quality index value of the presentation object.

The historical text evaluation information usually contains words such as “good”, “like”, and “bad” that reflect the quality of the presentation object. Therefore, similar to the DSR, the historical text evaluation information may also be used to determine the poor-quality index value of the presentation object.

When the refund rate of the presentation object is high, it indicates that most second users may not be satisfied with the presentation object after purchasing the presentation object. In this case, the presentation object may be a presentation object with poor quality and the refund rate may be used to determine the poor-quality index value of the presentation object.

More specifically, the poor-quality index value in step a1 may be determined by using an existing stepwise regression model by including the DSR score, the price information, the historical text evaluation information, and the refund rate of the store to which the presentation object belongs.

Step b1:

Predict a sales volume index value of the presentation object.

The presentation object was regularly sold on the main server before. The sales volume index value of the presentation object may be predicted by using a historical sales volume at regular sales and in combination with other factors (such as a promotion effort value and a seasonality factor).

Specifically, the sales volume index value of the presentation object may be predicted by using the following techniques: predicting the sales volume index value of the presentation object according to one or more of the following: features of the presentation object, historical transaction behavior features, operation features of the store to which the presentation object belongs, and service features of an online shopping platform where the presentation object is to be presented; the features of the presentation object used in step b1 include one or more of a price, an inventory, a category, a gender preference, and a consumption level.

The historical transaction behavior features used in step b1 include one or more of a sales volume, a refund rate, a favorable rate, a sales volume, a refund rate, a poor evaluation rate, an adding to favorite volume, a search volume, and a browse volume.

The store operation features used in step b1 include one or more of a star level, a delivery speed, quality of service, and a store operation time.

The online shopping platform service features used in step b1 include one or more of a main category and a promotion effort value.

Specifically, data related to one or more of the features of the presentation object, the historical transaction behavior features, the operation features of the store to which the presentation object belongs, and the service features of the online shopping platform where the presentation object is to be presented may be initially processed; and then the sales volume of the presentation object may be predicted by using an existing iterative decision tree Gradient Boosted Regression Tree (“GBRT”) prediction algorithm.

Step c1:

Determine a comprehensive score of the presentation object according to the determined poor-quality index value and the predicted sales volume index value.

Because the determined index value can reflect the poor-quality of the presentation object, the predicted sales volume reflects demands of second users for the presentation object. In the disclosed embodiments, the purpose of selecting presentation objects by the sub-server is to select those presentation objects that have relatively high quality and are highly demanded by second users. Therefore, it is necessary to determine the comprehensive score of the presentation object according to the determined poor-quality index value and the predicted sales volume index value; the comprehensive score can reflect the level of quality of the presentation object and the demands for the presentation object.

Assuming that the normalized poor-quality index value is p and the normalized sales volume index value is q; in step c1, the comprehensive score S of the presentation object may be obtained by using the following formula (1):

S=\sqrt{(1−p)²+q²} (1)

Certainly, it is not limited to use other formulas to determine the comprehensive score of the presentation object. For example, the comprehensive score S of the presentation object is obtained by using a formula (2):

$$S = P 1 \times \frac{X}{M} + P 2 \times \frac{N}{Y} \qquad ( 2 )$$

M represents the poor-quality index value; P1 and P2 represent weighting factors, wherein P1+P2=1; N represents the sales volume index value; and X and Y are fixed values.

Step d1:

Determine whether the comprehensive score of the presentation object is within a set interval range; and if so, perform step e1; and if not, perform step f1.

The set interval range may be determined according to empirical values.

Step e1:

Use the presentation object as a selected presentation object.

In this case, the presentation objects selected in step e1 are usually presentation objects with a lower poor-quality index value and a higher predicted sales volume; and these presentation objects will be selected and can be included subsequently in the service of the sub-server.

Step f1:

Filter out the presentation object.

In this case, the presentation objects selected in step f1 are usually presentation objects with both a lower predicted sales volume and a higher poor-quality index value; and these presentation objects will be filtered out and cannot be included subsequently in the service of the sub-server.

After the selection process in step a1 to step f1 above, presentation objects with a higher poor-quality index value and presentation objects with a lower predicted sales volume are filtered out; and presentation objects subsequently provided to a second user are presentation objects with a lower poor-quality index value and a higher predicted sales volume, which may be considered as high-quality presentation objects. For the second user, the time spent by the second user selecting a presentation object to be purchased is reduced, therefore improving the purchase experience. For the sub-server, the space for storing presentation objects with a lower predicted sales volume and poor-quality presentation objects is saved; and the pressure brought to the second users because of their browsing presentation objects with a higher poor-quality index value and a lower predicted sales volume (such browsing will not bring a sales volume to a large extent) is reduced. Moreover, because the sub-server subsequently provides to the second users the presentation objects with a lower poor-quality index value and a higher predicted sales volume, these presentation objects are more likely to be purchased by the second users, thereby increasing the purchase conversion rates of presentation objects.

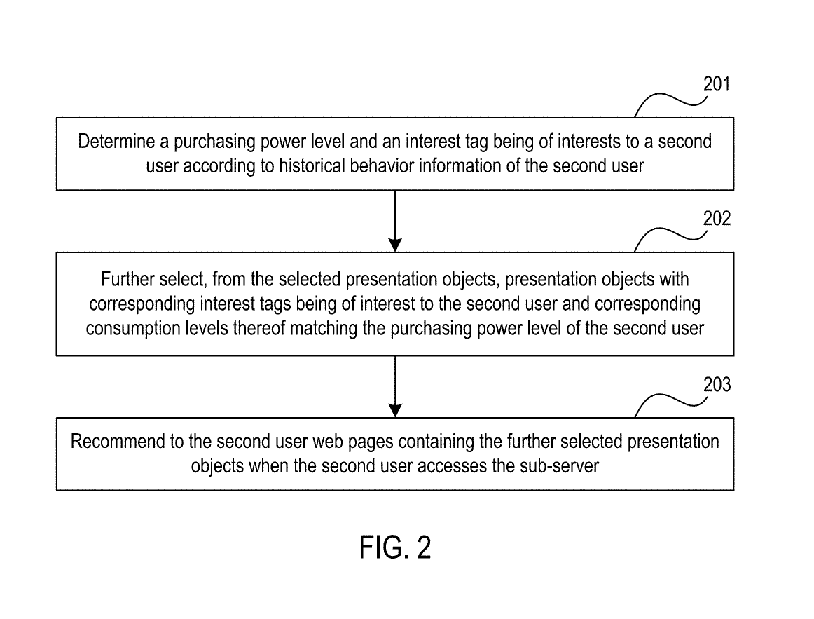

After the sub-server selects the presentation objects, the selected presentation objects may be recommended to a second user accessing the sub-server. A method for recommending a presentation object is described below with the solution in the embodiments described in FIG. 2.

FIG. 2 is a flow diagram of a method for recommending a presentation object according some embodiments of the disclosure. The embodiment illustrated in FIG. 2 provides a method for recommending a presentation object, wherein the presentation object may be a presentation object selected by using the method for selecting a presentation object in the embodiments described in FIG. 1. The method shown in FIG. 2 includes the following steps.

Step 201:

Determine a purchasing power level and an interest tag being of interest to a second user according to historical behavior information of the second user.

Herein, each presentation object corresponds to one or more consumption levels and one or more interest tags.

Each presentation object corresponds to specific price information. Prices are divided into at least two price ranges according to price information of the presentation object and price information of presentation objects in the same category (that is, presentation objects under the same category). Corresponding relationships between the price ranges and consumption levels are established, then a price range in which the price of the presentation object falls is determined and finally a consumption level corresponding to the presentation object may be obtained from the corresponding relationships between the price ranges and the consumption levels.

The interest tag may refer to the context where the presence of the presentation object is ideal or a reported preference of a purchaser after the presentation object is used. For example, for a presentation object of an outdoor jacket, which is suitable for traveling and outdoor sports, the corresponding interest tags may be traveling and outdoor sports. For a presentation object of a plaid bag, for which the reported preferences of the purchaser after use is shopping-loving, graceful, Chanel-stylish, or ladylike, the corresponding interest tags may be graceful, Chanel-stylish, ladylike, and shopping-loving.

Specifically, the purchasing power level of the second user may be determined through the following means: determining the purchasing power level of the first user according to a consumption level corresponding to a price range to which a price of each presentation object purchased by the second user belongs, wherein the price range is a price range of a category to which the presentation object belongs; and each category corresponds to multiple price ranges.

For example, if the price of each second user A-brand women's shoulder bag purchased by a first user 1 is 300 yuan, 300 falls within a price range of greater than or equal to 250 and less than or equal to 400 within the category of plaid bag; and a price range of greater than or equal to 280 and less than or equal to 500 corresponds to a consumption level of 2, then the purchasing power level of the first user is level 2.

Herein, for simplicity, the price of only one presentation object purchased by the second user is used for description in the example. Certainly, the purchasing power level of the second user may be determined according to prices of multiple presentation objects purchased by the second user. In this case, the obtained purchasing power level of the second user will be more accurate.

The historical behavior information of the second user may include: a behavior, an occurrence time of the behavior, and an identifier of the service object targeted by the behavior; and the behavior includes: purchasing, browsing, adding to a shopping cart, and adding to favorite.

Specifically, the interest tag of interests of the second user may be determined through the following steps a2 to d2.

Step a2:

Determine leaf categories corresponding to presentation objects indicated by identifiers of each presentation object contained in the historical behavior information of the second user.

The leaf categories are categories under which no more sub-category exists.

For example, historical behavior information of the second user 1 is shown in the following table (1). A presentation object indicated by an identifier 0112890 is an A-brand women's plaid shoulder bag; a presentation object indicated by an identifier 0112899 is a B-brand women's plaid hand-held bag; and it is determined that a leaf category corresponding to the A-brand women's shoulder bag and the B-brand women's plaid hand-held bag is plaid bag.

TABLE (1)

| | Behavior of second user 1 | | | | | |
|---|---|---|---|---|---|---|
| | Browsing | Collecting | Browsing | Purchasing | Browsing | Collecting |
| Behavior | July 5, | July 5, | July 7, | July 7, | July 7, | 2015 |
| observed | 2015 | 2015 | 2015 | 2015 | 2015 | July 7, |
| time | at 12:00 | at 12:02 | at 19:07 | at 19:10 | at 19:15 | 2015 |
| | | | | | | at 19:18 |
| Identifier of | 0112890 | 0112890 | 0112890 | 0112890 | 0112899 | 0112899 |
| the | | | | | | |
| presentation | | | | | | |
| object | | | | | | |
| targeted by | | | | | | |
| the behavior | | | | | | |

In table (1), using the second column as an example; it indicates that the second user 1 browsed a presentation object identified as 0112890 at 12:00 on Jul. 5, 2015.

For each determined leaf category, the following operations are performed.

Step b2:

Divide behaviors of the second user under the leaf category into at least one behavior cluster, wherein a difference between occurrence times of any two behaviors belonging to the same behavior cluster is within a set time range.

Considering that when searching for an interested presentation object, the second user usually does not usually just view, search, add to favorite, and add only a single presentation object to a shopping cart constantly, which causes that behaviors to be excessively scattered if a behavior cluster is calculated by using a single presentation object. It is not likely for a second user to have continuous and consistent behaviors on a single commodity that are sufficient to form a large cluster. Therefore, a behavior cluster under a leaf category is used as the behavior cluster in this embodiment, instead of using a behavior cluster for a single presentation object.

Still using the example in step a2, assuming that a set time range is 2 hours; the behaviors of the second user 1 under the category of plaid bag may be divided into two behavior clusters: a behavior cluster 1 and a behavior cluster 2. The behavior cluster 1 includes two behaviors: browsing and adding to favorite and the behavior cluster 2 includes a total of four behaviors: browsing, purchasing, and adding to favorite.

Step c2:

Determine whether the second user is interested in the leaf category according to the divided behavior cluster.

Specifically, whether the second user is interested in the leaf category may be determined according to the divided behavior cluster in the following two manners.

Manner 1: Correspondingly set a score for each behavior in advance; and then summarize set scores corresponding to behaviors included in each behavior cluster to obtain a score for each behavior cluster; then compare the maximum score value of the second user in behavior clusters under the category with a set first threshold of interest; and if the maximum value is greater than the first threshold of interest, determine that the second user is interested in the leaf category; otherwise, determine that the second user is not interested in the leaf category.

Still using the example in step b2, assuming that a set score corresponding to adding to favorite is 3 points; a set score corresponding to browsing is 2 points; and a set score corresponding to purchasing is 6 points. In manner 1, an obtained score of the behavior cluster 1 is 5 points, and a score corresponding to the behavior cluster 2 is 13 points. The highest score of the behavior clusters of the second user 1 under the leaf category of plaid bag is 13 points. Assuming that the set first threshold of interest is 6, because the highest score 13 points is greater than 6 points, it is determined that the second user 1 is interested in the leaf category of plaid bag.

Manner 2: Count the numbers of behaviors included in behavior clusters; and determine the maximum value of the numbers of the included behaviors; and when the maximum value is greater than a set second threshold of interest, determine that the maximum value is greater than the second threshold of interest, and determine that the second user is interested in the leaf category; otherwise, determine that the second user is not interested in the leaf category.

Still using the example in step b2, the number of behaviors of the second user 1 included in the behavior cluster 1 under the leaf category of plaid bag is 2; and the number of behaviors included in the behavior cluster 2 under the leaf category of plaid bag is 4; and when the second threshold of interest is 3, it is determined that the second user 1 is interested in the leaf category of plaid bag.

Step d2:

Use an interest tag corresponding to the leaf category as the interest tag being of interest to the second user when it is determined that the second user is interested in the leaf category.

Still using the example in step c2, in step d2, it is determined that the second user 1 is interested in the leaf category of plaid bag, and the interest tags corresponding to the plaid bag, i.e., graceful, Chanel-stylish, ladylike, and shopping-loving are determined to be interest tags of interests to the second user 1.

Step 202:

Further select, from the selected presentation objects, presentation objects with corresponding interest tags being of interest to the second user and corresponding consumption levels thereof matching the purchasing power level of the second user.

When the purchasing power level of the second user matches a consumption level of a presentation object in which the second user is interested, the second user is more likely to purchase the interested presentation object. The matching herein may be that the purchasing power level of the second user and a consumption level of a presentation object in which the second user is interested are the same; or it may be the absolute value of a difference between the two falling within a set number of levels.

In step 202, during the further selection, in addition to considering the interest tag being of interests to and the consumption level of the second user, when a presentation object has a gender tendency, the gender of the second user may also be considered. That is, a presentation object for which a corresponding interest tag includes the interest tag of interests to the second user, a corresponding consumption level matching the purchasing power level of the second user, and a corresponding gender matching the gender of the second user are further selected.

Step 203:

Recommend to the second user web pages containing the further selected presentation objects when the second user accesses the sub-server.

During recommendation, a personalized presentation web page may be set for the second user and the further determined presentation object or a category that the presentation object belongs may be presented on the visited home page when the second user accesses the web page. Alternatively, the further determined presentation object may be displayed in a presentation object recommendation area on each web page.

Considering that the number of further selected presentation objects may be greater than a set recommended number or may be less than a set recommended number and to recommend the set recommended number of presentation objects to the second user, preferably, before recommending a web page containing the further selected presentation object to the second user when the second user accesses the sub-server, the method further includes: determining whether the number of further selected presentation objects is less than a set recommended number; if a determination result is positive, determining probabilities of the second user purchasing presentation objects from the selected displayed objects, but not the further selected presentation objects according to features of the second user, features of the selected presentation objects, operation features of stores to which the selected presentation objects belong, and service features of online shopping platforms where the presentation objects are to be placed; and sorting the presentation objects in the selected displayed objects but not the further selected presentation objects in the descending order of the probabilities that the second user purchasing the presentation objects, wherein the features of the second user comprise one or more of a purchasing power level, gender, browsing features, and purchasing features.

Specifically, the probabilities that the second user purchases the presentation objects from the selected displayed objects but not the further selected presentation object may be determined by using a GBRT algorithm according to features of the second user, features of the selected presentation objects, operation features of stores to which the selected presentation objects belong, and service features of online shopping platforms where the presentation objects are to be placed.

In this case, step 203 specifically includes: recommending to the first user web pages containing the further selected presentation objects and the first M sorted presentation objects when the second user accesses the sub-server, where M is a difference between a set recommended number and the number of further selected presentation objects.

If a determination result is not, for each further selected presentation object, scores of interest tags corresponding to the presentation object are determined; and the maximum value of the scores is used as an interest value of the second user for the presentation object; and the further selected presentation objects are sorted in descending order per the determined interest values.

Herein, the example in step d2 is still used for description.

It can be seen from step d2 that the interest tags of interests to the second user 1 is graceful, Chanel-stylish, ladylike, and shopping-loving. In this case, the highest score of 13 points of the behavior clusters of the second user 1 under the leaf category of plaid bag may be used as interest values of these interest tags of graceful, Chanel-stylish, ladylike, and shopping-loving; and an interest value of an interest tag among interest tags corresponding to the further selected presentation objects that matches the interest tags of interests to the second user 1 may also be set to 13. For example, assuming that the further selected objects include an A-brand casual dress and a B-brand bracelet; interest tags corresponding to the A-brand casual dress include shopping-loving and interest tags corresponding to the B-brand bracelet also include ladylike; then an interest value of the interest tag of shopping-loving corresponding to the A-brand casual dress is also set to 13; and an interest value of the interest tag of ladylike corresponding to the B-brand bracelet is also set to 13.

In this case, step 203 specifically includes: recommending to the second user a web page containing first set recommended number of sorted presentation objects when the second user accesses the sub-server.

In the solution of embodiments illustrated in FIG. 2, when presentation objects selected in the embodiments described in FIG. 1 are recommended to a user, in combination with historical behavior information of the second user, a presentation object for which a corresponding interest tag includes an interest tag of interests to the second user and a corresponding consumption level matches a purchasing power level of the second user is further selected. Because recommended presentation objects are presentation objects matching the second user, the second user can rapidly select a desired presentation object from the recommended presentation objects, thereby improving the user experience and increasing the purchase conversion rates of presentation objects.

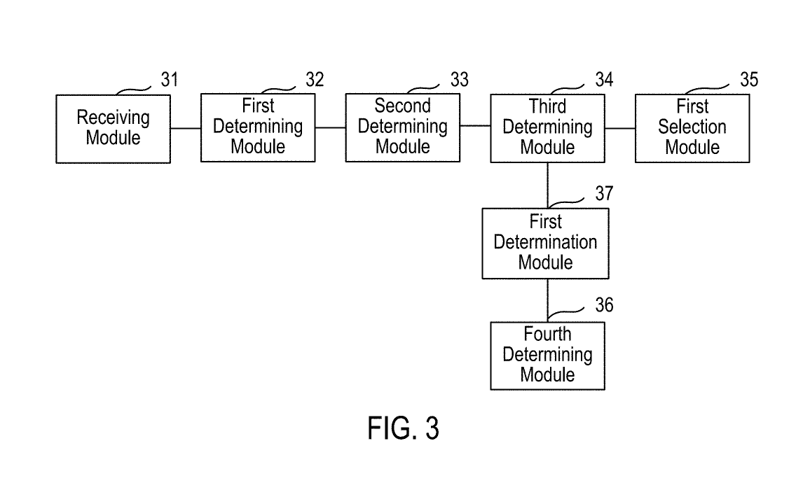

In accordance with the embodiments discussed in FIG. 1, the embodiment illustrated in FIG. 3 provides an apparatus for selecting a presentation object, and a block diagram of the apparatus is shown in FIG. 3, including: a receiving module 31, configured to receive service participation request messages sent by each first user terminal, wherein the service participation request messages include identifiers of presentation objects; a first determining module 32, configured to determine, according to corresponding relationships between the identifiers of the presentation objects and identifiers of first users obtained from a main server, identifiers of first users corresponding to the identifiers of the presentation objects included in the received service participation request messages; a second determining module 33, configured to obtain, from the main server, historical behavior information of the first users indicated by the determined identifiers of the first users; a third determining module 34, configured to determine, according to the obtained historical behavior information of the first users, first users satisfying a set service participation condition; and a first selection module 35, configured to select a presentation object from presentation objects for which the request to participate in a service is placed by the first users satisfying the set service participation condition.

Preferably, the historical behavior information of the first users comprises one or more of a historical penally score, a record of selling counterfeits, a record of defrauding second users, a record of selling objects prohibited to be presented, a record of false certifications, and a bribery record; a greater number of records of selling counterfeits, records of defrauding, records of selling objects prohibited to be presented, records of using false certifications and records of bribery gives rise to a higher historical penally score.

Preferably, the third determining module 34 is specifically configured to do the following: regarding a first user indicated by each determined identifier of the first user, determine whether a historical penalty score of the first user is less than a first set value; and if so, determine that the first user is a first user satisfying the set service participation condition; and if not, determine that the first user is a first user not satisfying the set service participation condition.

Preferably, the historical behavior information of the first users further includes a store registration record and a store login record; and the apparatus further comprises:

a fourth determining module 36, configured to determine unethical first users according to historical behavior information of first users from first users indicated by identifiers of the first users stored in the main server but not the first users indicated by the determined identifiers of the first users, wherein the unethical first users comprise: a first user selling counterfeits, a first user defrauding a second user, a first user selling an object prohibited to be presented, a first user using a false certification, and a first user having a bribery issue; the apparatus further comprises a first determination module 37, configured to do the following: after the third determining module determines that the historical penalty score of the first user is less than the first set value and before the third determining module determines the first user as a first user satisfying the set service participation condition, determine whether any unethical first user exists in the determined unethical first users that is the same first user as the first user comprises according to the store registration record and the store login record of the first user; and the third determining module 34 is specifically configured to determine that the first user is a first user satisfying the set service participation condition if a determination result of the first determination module is that no unethical first user exists in the determined unethical first users that is the same first user as the first user.

Preferably, the store login record includes a login duration at a store, an identifier of a device used for logging into the store, and a network Internet Protocol (IP) address used to log into the store; and the fourth determining module 36 is specifically configured to determine whether any one or more of the following three types of unethical first users in the determined unethical first users, and if so, determining that an unethical first user exists that is the same first user as the first user; and if not, determining that no unethical first user exists that is the same first user as the first user: the first type of unethical first user: an unethical first user that logs into a store by using a device having the same identifier as the identifier of the device used by the first user to login to the store, and logs into the store by using the device for a duration greater than a second set value; the second type of unethical first user: an unethical first user who logs into a store by using the same IP address as the IP address used by the first user to login to the store, and logs into the store by using the IP address for a duration greater than the second set value; and the third type of unethical first user: an unethical first user who has a store registration record having a similarity to the store registration record of the first user greater than a third set value.

Preferably, the first selection module 35 is specifically configured to perform the following operations for each presentation object for which the request to participate in a service is placed by the first users satisfying the set service participation condition: determining a poor-quality index value of the presentation object; predicting a sales volume index value of the presentation object; determining a comprehensive score of the presentation object according to the determined poor-quality index value and the predicted sales volume index value; and using the presentation object as a selected presentation object if the comprehensive score of the presentation object is within a range of a set interval.

Preferably, the first selection module 35 is specifically configured to determine the poor-quality index value of the presentation object according to one or more of the following information of a store to which the presentation object belongs: a detailed first user rating DSR score, price information, historical text evaluation information, and refund rate information.

Preferably, the first selection module 35 is specifically configured to predict the sales volume index value of the presentation object according to one or more of the following: features of the presentation object, historical transaction behavior features, operation features of the store to which the presentation object belongs, and service features of an online shopping platform where the presentation object is to be presented, wherein the features of the presentation object comprise one or more of a price, an inventory, a category; the historical transaction behavior features comprise one or more of a sales volume, a refund rate, a favorable rate; the store operation features comprise one or more of the following information of a store: a star level, a delivery speed, quality of service; and the online shopping platform service features comprise one or more of a main category and a promotion value.

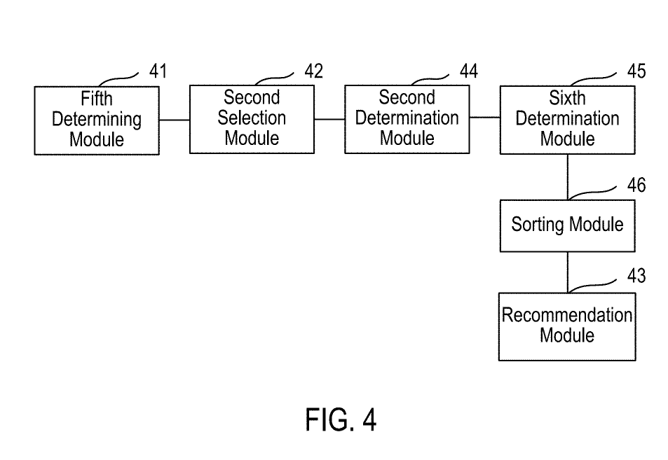

In accordance with the embodiments described in FIG. 2, the embodiment illustrated in FIG. 4 provides an apparatus for selecting a presentation object; and a block diagram of the apparatus is shown in FIG. 4, wherein each presentation object corresponds to one or more consumption levels and one or more interest tags; and the recommendation apparatus includes: a fifth determining module 41, configured to determine a purchasing power level and an interest tag being of interests to a second user according to historical behavior information of the second user; a second selection module 42, configured to further select, from the selected presentation objects, presentation objects with corresponding interest tags being of interest to the second user and corresponding consumption levels thereof matching the purchasing power level of the second user; and a recommendation module 43, configured to recommend to the second user web pages containing the further selected presentation objects when the second user accesses the sub-server.

Preferably, each leaf category corresponds to one or more interest tags, and the historical behavior information of the second user comprises: a behavior, an occurrence time of the behavior, and an identifier of a presentation object targeted by the behavior; and the behavior comprises: purchasing, browsing, adding to a shopping cart, and adding to favorite; and the second selection module 42 is specifically configured to determine the interest tag being of interests to the second user through the following manner: determining leaf categories corresponding to presentation objects indicated by identifiers of each presentation object contained in the historical behavior information of the second user; and performing the following operations for each determined leaf category: dividing behaviors of the second user under the leaf category into at least one behavior cluster, wherein a difference between occurrence times of any two behaviors belonging to the same behavior cluster is within a set time range; determining whether the second user is interested in the leaf category according to the divided behavior cluster; and using an interest tag corresponding to the leaf category as the interest tag being of interest to the second user when it is determined that the second user is interested in the leaf category.

Preferably, the recommendation apparatus further includes: a second determination module 44, configured to determine whether the number of further selected presentation objects is less than a set recommended number before the web pages containing the further selected presentation objects are recommended to the second user when the second user accesses the sub-server; a sixth determining module 45, configured to do the following: when the number of further selected presentation objects is less than the set recommended number, determine probabilities of the second user purchasing presentation objects from the selected displayed objects but not the further selected presentation objects according to features of the second user, features of the selected presentation objects, operation features of stores to which the selected presentation objects belong, and service features of online shopping platforms where the presentation objects are to be placed, wherein the features of the second user comprise one or more of a purchasing power level, gender, browsing features, and purchasing features; and a sorting module 46, configured to sort the presentation objects in the selected displayed objects but not the further selected presentation objects in the descending order of the probabilities that the second user purchasing the presentation objects; and the recommendation module 43 is specifically configured to recommend to the first user web pages containing the further selected presentation objects and the first M sorted presentation objects when the second user accesses the sub-server, wherein M is a difference between a set recommended number and the number of further selected presentation objects.

Through the above description of the embodiments, those skilled in the art may clearly understand that the embodiments of the disclosure may be implemented by hardware or by means of software for a needed universal hardware platform. Based on this understanding, the technical solutions in the embodiments of the disclosure may be embodied in the form of a software product that can be stored in a non-volatile storage medium (which may be a CD-ROM, a USB flash disk, a removable hard disk, etc.) including several instructions for enabling a computer device (which may be a personal computer, a server, or a network device) to execute the methods described in the embodiments of the disclosure.

Those skilled in the art can understand that the accompanying drawings are merely schematic diagrams of embodiments, and the modules or processes in the accompanying drawings are not necessarily required to implement the disclosure.

Those skilled in the art can understand that modules in a terminal in an embodiment may be distributed in the terminal in the embodiment as described in the embodiment; or corresponding changes may be made and the modules may be disposed in one or more terminals different from that embodiment. The modules in the foregoing embodiment may be combined into one module, or may further be divided into multiple sub-modules.

The sequence numbers of the above embodiments of the disclosure are merely for the purpose of description and do not indicate the superiority or inferiority of the embodiments.

Obviously, those skilled in the art can make various modifications and variations to the disclosure without departing from the spirit and scope of the disclosure. In such cases, the disclosure is also intended to encompass these modifications and variations if these modifications and variations of the disclosure fall within the scope of the claims of the disclosure and equivalent technologies thereof.

1-22. (canceled)

23. A method comprising:
receiving, at a sub-server, a service participation request message from a first user terminal, the service participation request message including identifiers representing a plurality of presentation objects;
identifying, by the sub-server, a set of first users associated with the identifiers;
retrieving, by the sub-server, historical behavior information associated with the set of first users from a main server;
identifying, by the sub-server, a subset of the first users, the identification of the subset of first users representing one or more first users meeting a set service participation condition; and
selecting, by the sub-server, a presentation object from the plurality of presentation objects, the presentation object being associated with a selected user from the subset of the first users.

24. The method of claim 23, retrieving historical behavior information comprising retrieving a store registration record, a store login record, a historical penalty score, a record of selling counterfeits, a record of defrauding second users, a record of selling objects prohibited to be presented, a record of false certifications, and a bribery record.

25. The method of claim 24, further comprising generating the historical behavior information based on a record of second user complaints and a record of network administrator examinations.

26. The method of claim 23, the identifying a subset of the first users meeting a set service participation condition comprising filtering the set of first users based on the historical behavior information.

27. The method of claim 26, the filtering the set of first users based on the historical behavior information comprising excluding a user in the set of first users if a historical penalty score associated with the user is greater than a set value, the historical penalty score generated based on a number and severity of unethical records of the user.

28. The method of claim 27, the excluding a user in the set of first users if a historical penalty score associated with the user is greater than a set value comprising:
determining, by the sub-server, unethical first users according to historical behavior information of set of first users;
determining, by the sub-server, according to store registration records and store login records of the first user, whether any unethical first user exists in the unethical first users that is the same as the user; and
determining, by the sub-server, that the user satisfies the set service participation condition if the user is the same as an unethical first user.

29. The method of claim 23, the selecting a presentation object from the plurality of presentation objects comprising:
determining, by the sub-server, a poor-quality index value of the presentation object;
predicting, by the sub-server, a sales volume index value of the presentation object;
determining, by the sub-server, a comprehensive score of the presentation object according to the poor-quality index value and the predicted sales volume index value;
determining, by the sub-server, whether the comprehensive score of the presentation object is within a set interval range;
using, by the sub-server, the presentation object as a selected presentation object if the presentation object is within a set interval range; and
filtering out, by the sub-server, the presentation object if the presentation object is not within a set interval range.

30. The method of claim 23, the selecting a presentation object from the plurality of presentation objects further comprising:
determining, by the sub-server, a purchasing power level and an interest tag being of interest to a second user according to historical behavior information of the second user;
further selecting, by the sub-server, from the selected presentation objects, presentation objects with corresponding interest tags being of interest to the second user and corresponding consumption levels thereof matching the purchasing power level of the second user; and
recommending, by the sub-server, to the second user web pages containing the further selected presentation objects when the second user accesses the sub-server.

31. The method of claim 30, further comprising determining an interest tag being of interest to a second user by:
determining, by the sub-server, leaf categories corresponding to presentation objects indicated by identifiers of each presentation object contained in the historical behavior information of the second user;
dividing, by the sub-server, behaviors of the second user under the leaf category into at least one behavior cluster, a difference between occurrence times of any two behaviors belonging to the same behavior cluster is within a set time range;
determining, by the sub-server, whether the second user is interested in the leaf category according to the divided behavior cluster; and
using, by the sub-server, an interest tag corresponding to the leaf category as the interest tag being of interest to the second user when it is determined that the second user is interested in the leaf category.

32. The method of claim 30, further comprising:
determining, by the sub-server, whether the number of selected presentation objects is less than a set recommended number;
determining, by the sub-server, probabilities of the second user purchasing presentation objects from the selected displayed objects, but not the further selected presentation objects according to features of the second user, features of the selected presentation objects, operation features of stores to which the selected presentation objects belong, and service features of online shopping platforms where the presentation objects are to be placed; and
sorting, by the sub-server, the presentation objects in the selected displayed objects but not the further selected presentation objects in the descending order of the probabilities that the second user purchasing the presentation objects, wherein the features of the second user comprise one or more of a purchasing power level, gender, browsing features, and purchasing features.

33. An apparatus comprising:
a processor; and
a storage medium for tangibly storing thereon program logic for execution by the processor, the stored program logic comprising:
logic, executed by the processor, for receiving a service participation request message from a first user terminal, the service participation request message including identifiers representing a plurality of presentation objects;
logic, executed by the processor, for identifying a set of first users associated with the identifiers;
logic, executed by the processor, for retrieving historical behavior information associated with the set of first users from a main server;
logic, executed by the processor, for identifying a subset of the first users, the identification of the subset of first users representing one or more first users meeting a set service participation condition; and
logic, executed by the processor, for selecting a presentation object from the plurality of presentation objects, the presentation object being associated with a selected user from the subset of the first users.

34. The apparatus of claim 33, the logic for retrieving historical behavior information comprising logic, executed by the processor, for retrieving a store registration record, a store login record, a historical penalty score, a record of selling counterfeits, a record of defrauding second users, a record of selling objects prohibited to be presented, a record of false certifications, and a bribery record.

35. The apparatus of claim 34, further comprising logic, executed by the processor, for generating the historical behavior information based on a record of second user complaints and a record of network administrator examinations.

36. The apparatus of claim 33, the logic for identifying a subset of the first users meeting a set service participation condition comprising logic, executed by the processor, for filtering the set of first users based on the historical behavior information.

37. The apparatus of claim 36, the logic for filtering the set of first users based on the historical behavior information comprising logic, executed by the processor, for excluding a user in the set of first users if a historical penally score associated with the user is greater than a set value, the historical penally score generated based on a number and severity of unethical records of the user.

38. The apparatus of claim 37, the logic for excluding a user in the set of first users if a historical penalty score associated with the user is greater than a set value comprising:
logic, executed by the processor, for determining unethical first users according to historical behavior information of set of first users;
logic, executed by the processor, for determining according to store registration records and store login records of the first user, whether any unethical first user exists in the unethical first users that is the same as the user; and
logic, executed by the processor, for determining that the user satisfies the set service participation condition if the user is the same as an unethical first user.

39. The apparatus of claim 33, the logic for selecting a presentation object from the plurality of presentation objects comprising:
logic, executed by the processor, for determining a poor-quality index value of the presentation object;
logic, executed by the processor, for predicting a sales volume index value of the presentation object;
logic, executed by the processor, for determining a comprehensive score of the presentation object according to the poor-quality index value and the predicted sales volume index value;
logic, executed by the processor, for determining whether the comprehensive score of the presentation object is within a set interval range;
logic, executed by the processor, for using the presentation object as a selected presentation object if the presentation object is within a set interval range; and
logic, executed by the processor, for filtering out the presentation object if the presentation object is not within a set interval range.

40. The apparatus of claim 33, the logic for selecting a presentation object from the plurality of presentation objects further comprising:
logic, executed by the processor, for determining a purchasing power level and an interest tag being of interest to a second user according to historical behavior information of the second user;
logic, executed by the processor, for further selecting from the selected presentation objects, presentation objects with corresponding interest tags being of interest to the second user and corresponding consumption levels thereof matching the purchasing power level of the second user; and
logic, executed by the processor, for recommending to the second user web pages containing the further selected presentation objects when the second user accesses the sub-server.

41. The apparatus of claim 40, further comprising logic, executed by the processor, for determining an interest tag being of interest to a second user by:
determining leaf categories corresponding to presentation objects indicated by identifiers of each presentation object contained in the historical behavior information of the second user;
dividing behaviors of the second user under the leaf category into at least one behavior cluster, a difference between occurrence times of any two behaviors belonging to the same behavior cluster is within a set time range;
determining whether the second user is interested in the leaf category according to the divided behavior cluster; and
using an interest tag corresponding to the leaf category as the interest tag being of interest to the second user when it is determined that the second user is interested in the leaf category.

42. The apparatus of claim 40, further comprising:
logic, executed by the processor, for determining whether the number of selected presentation objects is less than a set recommended number;
logic, executed by the processor, for determining probabilities of the second user purchasing presentation objects from the selected displayed objects, but not the further selected presentation objects according to features of the second user, features of the selected presentation objects, operation features of stores to which the selected presentation objects belong, and service features of online shopping platforms where the presentation objects are to be placed; and
logic, executed by the processor, for sorting the presentation objects in the selected displayed objects but not the further selected presentation objects in the descending order of the probabilities that the second user purchasing the presentation objects, wherein the features of the second user comprise one or more of a purchasing power level, gender, browsing features, and purchasing features.
